(19) United States
(12) Patent Application Publication
(10) Pub. No.: US 2015/0248565 A1
(43) Pub. Date: Sep. 3, 2015

(54) INFORMATION SYSTEM, CONTROL PROGRAM FOR MANAGEMENT SERVER, AND CONTROL PROGRAM FOR MOBILE DEVICE

(71) Applicant: HITACHI, LTD., Tokyo (JP)

(72) Inventor: Nobuaki Onodera, Tokyo (JP)

(73) Assignee: HITACHI, LTD., Tokyo (JP)

(21) Appl. No.: 14/427,509

(22) PCT Filed: Nov. 20, 2012
(86) PCT No.: PCT/JP2012/080073

§ 371 Date: Mar. 11, 2015

(51) Int. Cl. G06F 21/62; G06F 17/30; H04L 29/08

(52) U.S. Cl. CPC G06F 21/6218; H04L 67/10; G06F 17/30241

(57) ABSTRACT

Provided is an information system, comprising mobile devices and a management server that communicates with the mobile devices, the management server holds policies each including a control rule for an information input part of each of the mobile devices and information specifying a geographical area to which the control rule is applied, one of the management server and the each of the mobile devices determines whether a location of the each of the mobile devices is included in at least one geographical area specified by at least one of the policies, and specifies the control rule to be applied to the each of the mobile devices based on the at least one policy when the acquired location is included in the at least one geographical area specified by the at least one policy, the each of the mobile devices controls the information input part based on the specified control rule.

### BACKGROUND OF THE INVENTION

This invention relates to an information system including a management server and a mobile device.

As a background art in this technical field, there is disclosed in Japanese Patent Application Publication No. 2009-545213. Japanese Patent Application Publication No. 2009-545213 describes the following: “Methods are disclosed for controlling mobile computing devices such as laptops, PDAs and cellular telephones, based on their location. A mobile computing device may include a software-rendered map of defined geographic regions, location handlers for defining behavior of a mobile device in a given geographic region, and a location handling engine for determining when a new geographic zone has been entered and exited, and for executing and terminating location handlers accordingly.” (See Abstract.)

### SUMMARY OF THE INVENTION

There are increasing needs for security management to control information leakage from a mobile terminal and unauthorized usage thereof with an increased use of mobile terminals. Because the characteristics of mobile terminals as mobile units have been improved in comparison with apparatus located at fixed locations such as conventional PCs, the mobile terminals are likely to be used in a variety of geographical areas. It is therefore necessary to perform non-uniform control based on geographical areas where mobile terminals are located while allowing for the characteristics of the mobile terminals as mobile units. In addition, for example, it may be necessary to control whether or not to permit the use of a function which may lead to information leakage among the functions of a mobile terminal in different manners depending on the duty of a person using that mobile terminal. To control the functions of a mobile terminal properly while preventing information leakage or the like in such a circumstance, it is desired to manage controlling of the functions of a plurality of mobile terminals in a centralized manner.

Japanese Patent Application Publication No. 2009-545213 discloses switching of the operation of a mobile terminal based on positional information. However, Japanese Patent Application Publication No. 2009-545213 does not disclose centralized management of controlling of functions relating to information leakage from a mobile terminal.

In order to solve the foregoing problem, this invention provides an information system comprises a plurality of mobile devices, and a management server that communicates with the plurality of mobile devices over a network, the management server comprising a first interface for communicating with the plurality of mobile devices over the network, a first processor coupled to the first interface, and a first storage device coupled to the first processor, each of the plurality of mobile devices comprising a second interface for communicating with the management server over the network, a second processor coupled to the second interface, a second storage device coupled to the second processor, an information input part coupled to the second processor, for acquiring a predetermined type of information from outside the each of the plurality of mobile devices, and a positional information acquiring part for acquiring positional information of the each of the plurality of mobile devices, the management server being configured to hold, in the first storage device, a plurality of policies each including a control rule for the information input part and information specifying a geographical area to which the control rule is applied, one of the management server and the each of the plurality of mobile devices being configured to determine whether a location of the each of the plurality of mobile devices acquired by the positional information acquiring part is included in at least one geographical area specified by at least one policy in the plurality of policies, and specify the control rule to be applied to the each of the plurality of mobile devices based on the at least one policy when the location of the each of the plurality of mobile devices acquired by the positional information acquiring part is included in the at least one geographical area specified by the at least one policy, the each of the plurality of mobile devices being configured to control the information input part based on the control rule to be applied to the each of the plurality of mobile devices.

According to one embodiment of this invention, the management server intensively manages controlling of the functions of the plurality of mobile terminals in a centralized manner, to thereby prevent information leakage or the like therefrom. Objects, configurations, and effects other than those described above become readily apparent from the following description of embodiments.

### BRIEF DESCRIPTION OF THE DRAWINGS

FIG. 1A is a block diagram illustrating the overall configuration of an information system according to a first embodiment of this invention.

FIG. 1B is a block diagram illustrating the configuration of a management server according to the first embodiment of this invention.

FIG. 1C is a block diagram illustrating the configuration of a mobile terminal according to the first embodiment of this invention.

FIG. 2 is an explanatory diagram of the relation between an area defined by a policy and an error in positional information acquired by a positional information acquiring part according to the first embodiment of this invention.

FIG. 3A is an explanatory diagram of the tolerance of positional information acquired by the positional information acquiring part according to the first embodiment of this invention.

FIGS. 3B to 3E are explanatory diagrams of first to fourth examples of the relation between positional coordinates acquired by the positional information acquiring part and actual positional coordinates of the mobile terminal according to the first embodiment of this invention.

FIGS. 4A to 4C are explanatory diagrams of tables included in a policy table according to the first embodiment of this invention.

FIG. 5 is an explanatory diagram of the relation among components constituting the first embodiment of this invention.

FIG. 6 is a flowchart illustrating a policy registering process that is performed by the management server according to the first embodiment of this invention.

FIG. 7 is an explanatory diagram of screens which are displayed when the management server according to the first embodiment of this invention performs the policy registering process.

FIG. 8 is an explanatory diagram of edition of the shape of a geographical area by the management server according to the first embodiment of this invention.

FIG. 9 is a flowchart illustrating an applied policy determining process that is performed by the mobile terminal according to the first embodiment of this invention.

FIG. 10 is an explanatory diagram of the user interface provided by the mobile terminal according to the first embodiment of this invention to display alteration of an applied policy.

FIG. 11 is an explanatory diagram of the user interface that displays an applied policy in accordance with control between policies applied to the mobile terminal according to the first embodiment of this invention.

FIG. 12 is an explanatory diagram of the user interface that displays definition information of a policy allocated to the mobile terminal according to the first embodiment of this invention.

FIG. 13 is an explanatory diagram for dynamic setting of the tolerance according to the first embodiment of this invention.

FIG. 14A is a block diagram illustrating the overall configuration of an information system according to a second embodiment of this invention.

FIG. 14B is a block diagram illustrating the configuration of a management server according to the second embodiment of this invention.

FIG. 14C is a block diagram illustrating the configuration of a mobile terminal management server according to the second embodiment of this invention.

FIG. 14D is a block diagram illustrating the configuration of a mobile terminal according to the second embodiment of this invention.

### DETAILED DESCRIPTION OF THE PREFERRED EMBODIMENTS

Now, a description is given of embodiments of this invention with reference to the attached drawings.

In the following description, although pieces of information of this invention are described by using such expressions as “aaa table”, “aaa list”, “aaa DB”, and “aaa queue” in some cases, those pieces of information may be expressed by in other forms than such data structures as a table, a list, a DB, a queue, and the like. Therefore, “aaa table”, “aaa list”, “aaa DB”, “aaa queue”, and the like are sometimes referred to as “aaa information” in order to show that those pieces of information are independent of their data structures.

In addition, although such expressions as “identification information”, “identifier”, “name”, “ID” are used in some cases in order to describe details of each piece of information, those expressions are interchangeable.

In the following description, although a description is given by using “program” as a subject in some cases, the program is executed by a processor to perform defined processing while using a memory and a communication port (communication control device). Therefore, “program” described as a subject in the description of processing can be replaced by “processor”. Further, processing disclosed while a program is used as a subject may also be interpreted as processing performed by a computer such as a management server or an information processing apparatus. Further, a part or all of processing executed by a processor in accordance with a program may also be implemented by dedicated hardware.

Further, various programs may also be installed onto each computer by a program distribution server or a computer-readable storage medium.

It should be noted that the management server includes an input/output device. Examples of the input/output device conceivably include a display, a keyboard, and a pointer device, but the input/output device may also be devices other than those devices. Further, a serial interface or an Ethernet interface may be used as a substitute for the input/output device. To be specific, an input and display of the input/output device may also be substituted by the following mode. Specifically, a computer for display including a display, a keyboard, or a pointer device is connected to the above-mentioned interface, and then, the management server transmits information for display to the computer for display and the computer for display performs display based on the information for display, or the management server receives information for input transmitted from the computer for display.

A set of at least one computer for managing an information processing system and displaying information for display of the invention of this application is hereinafter sometimes referred to as “management system”. In a case where the management server displays the information for display, the management server is the management system. Further, a combination of the management server and the computer for display is also the management system. Further, processing equivalent to that of the management server may also be implemented by a plurality of computers in order to speed up management processing and achieve a higher reliability, and in this case, the plurality of computers (including the computer for display in a case where the computer for display performs display) are the management system.

### First Embodiment

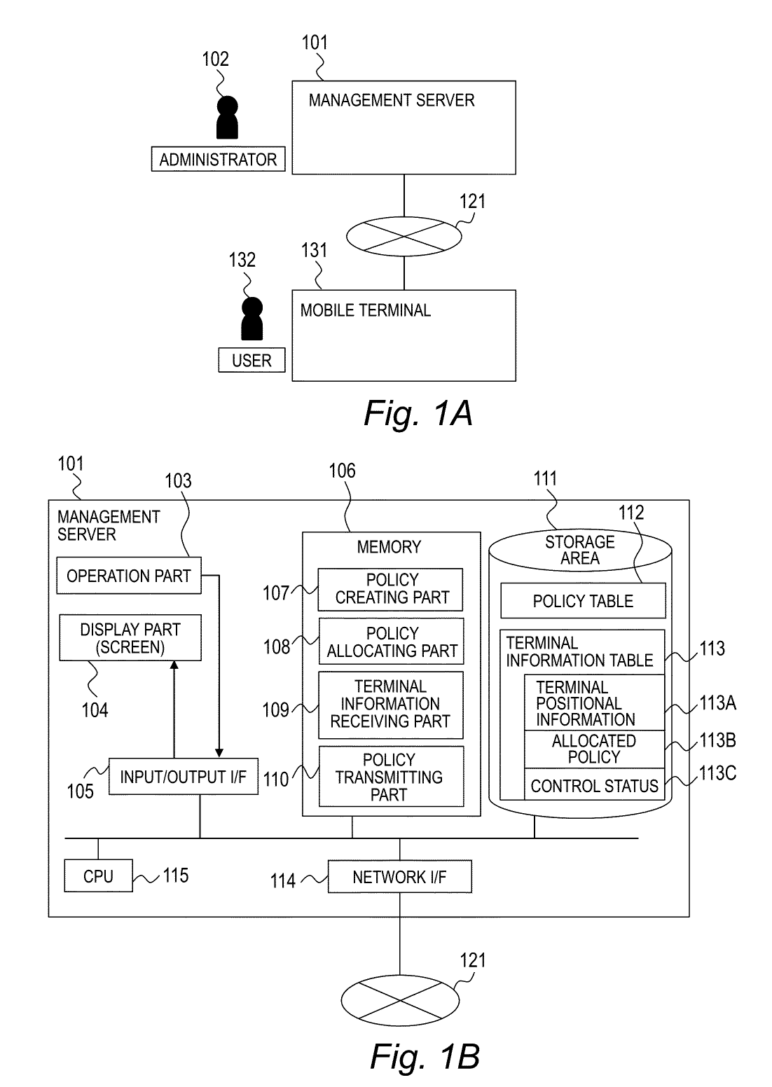

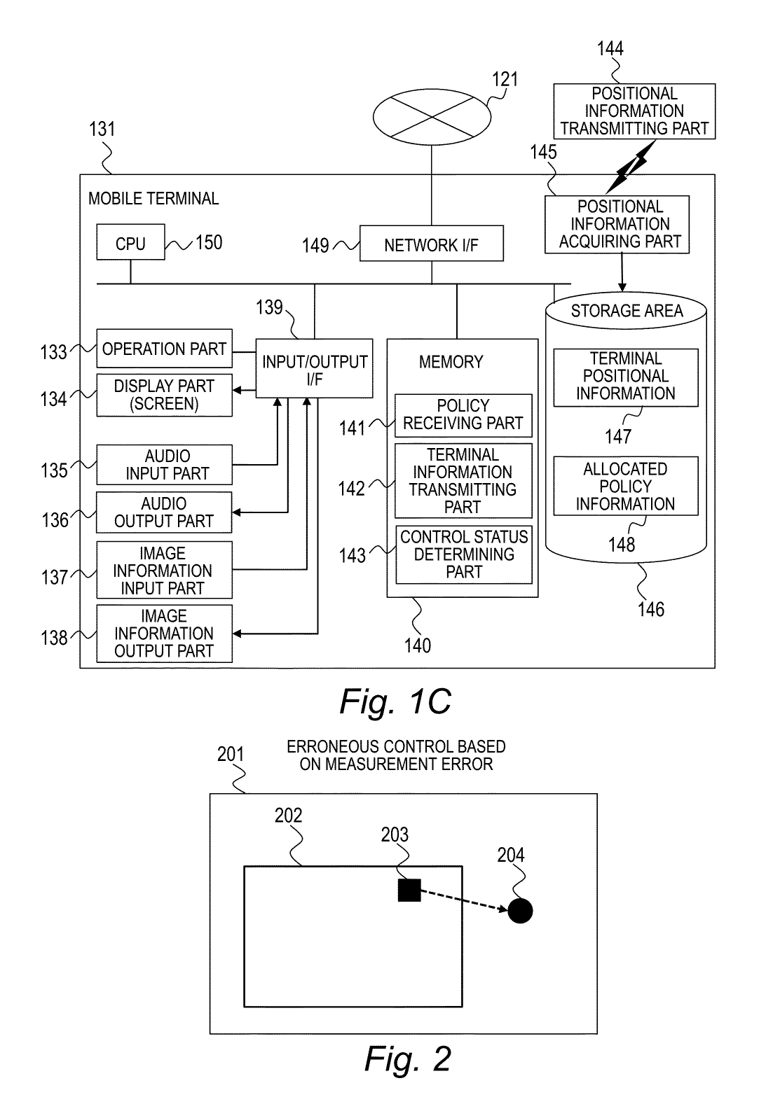

FIG. 1A is a block diagram illustrating the overall configuration of an information system according to a first embodiment of this invention.

The information system according to the first embodiment includes a management server 101 that is operated by an administrator 102, and a mobile terminal 131 to be managed coupled to the management server 101 over a communication network 121. Although FIG. 1A illustrates only a single mobile terminal 131 which is used by a single user 132, a plurality of mobile terminals 131 which are used by a plurality of users 132 are actually coupled to the management server 101 over the communication network 121. The administrator 102 sets policies for managing the individual mobile terminals 131 using the management server 101 as described later. The management server 101 applies the set policies to the individual mobile terminals 131 to manage the plurality of mobile terminals 131 in a centralized manner.

FIG. 1B is a block diagram illustrating the configuration of the management server 101 according to the first embodiment of this invention.

The management server 101 according to the first embodiment includes a central processing unit (CPU) 115, a network interface (I/F) 114, an input/output I/F 105, a memory 106, and a storage area 111 which are connected to one another.

The CPU 115 is a processor that performs various processes in accordance with a program stored in the memory 106. A program for a management server that is run by the CPU 115 is stored in the memory 106. A policy creating part 107, a policy allocating part 108, a terminal information receiving part 109, and a policy transmitting part 110 illustrated in FIG. 1B are program modules that constitute the management server program or a part thereof. The processes that are performed by those parts are described later.

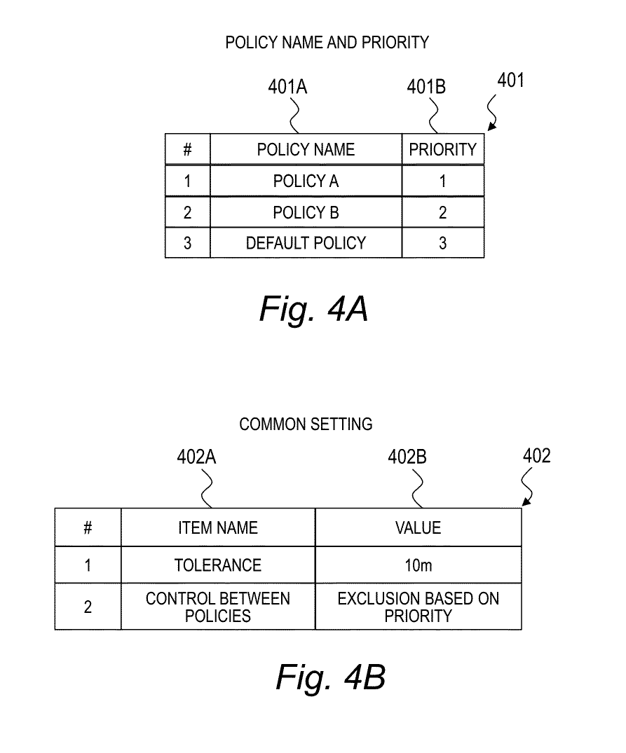

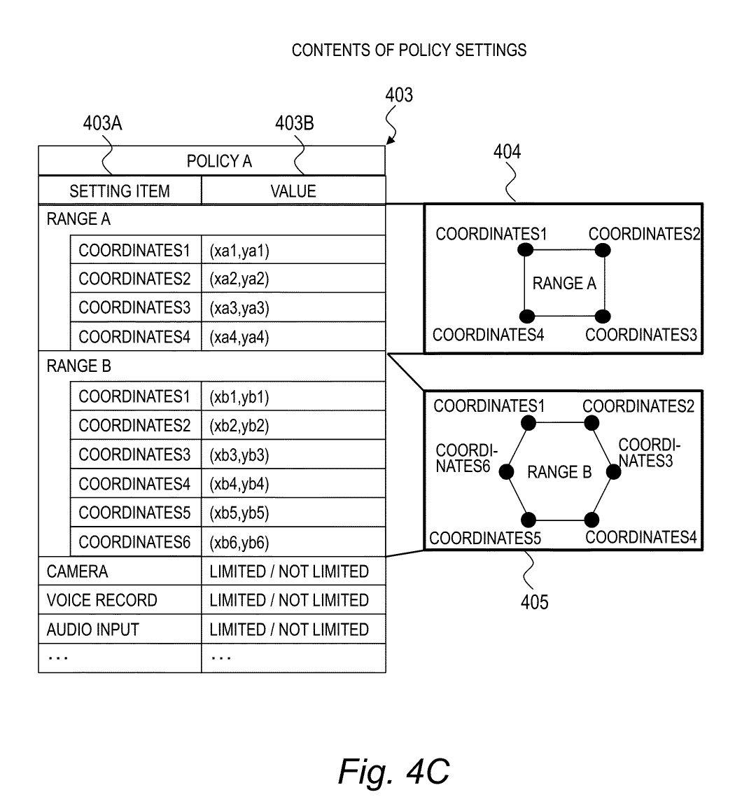

A policy table 112 which is referred to in order to control the plurality of mobile terminals 131, and a terminal information table 113 are stored in the storage area 111. The policy table 112 includes information defining a plurality of policies for determining control rules relating to the functions of each mobile terminal 131. Each policy surely includes at least one control rule relating to a function of each mobile terminal 131, and further may include information defining an area where the at least one control rule is applied. The details of the policy table 112 are described later with reference to FIGS. 4A to 4C.

The terminal information table 113 includes information on each mobile terminal 131. In the example of FIG. 1B, the terminal information table 113 includes terminal positional information 113A, an allocated policy 113B, and a control status 113C in addition to identification information (not shown) of the individual mobile terminals 131. The terminal positional information 113A represents the positions of the individual mobile terminals 131 acquired from the respective mobile terminals 131. The allocated policy 113B is information specifying policies allocated to the individual mobile terminals 131. The control status 113C is information representing control rules which are specified based on the policies allocated to the individual mobile terminals 131 and the positions of the individual mobile terminals 131, and are currently applied to the individual mobile terminals 131. The details of those pieces .of information are described later.

Each of the memory 106 and the storage area 111 may be achieved by any kind of storage device. Typically, the memory 106 may be a relatively fast semiconductor storage device, and the storage area 111 may be, for example, a database held in a relatively large-capacity storage device such as a hard disk drive. The program that is run by the CPU 115 may be stored in the storage area 111 so that the program may be partly or entirely copied into the memory 106 as needed. Further, the policy table 112 and the terminal information table 113 stored in the storage area 111 may be partly or entirely be copied into the memory 106 as needed.

An operation part 103 and a display part 104 are connected to the input/output I/F 105. The operation part 103 includes an input device, such as a keyboard and a pointer device, which is operated by the administrator 102. The display part 104 is an output device that outputs information to the administrator 102. For example, the display part 104 is an image display device that provides the administrator 102 with a graphical user interface (GUI) screen.

The network I/F 114 is the interface that couples the management server 101 to the communication network 121, and is used for communication between the management server 101 and the mobile terminal 131.

When receiving an operation by the administrator 102 using the GUI or the like via the operation part 103, the management server 101 transfers information on the operation to the internal management server program via the input/output I/F 105. A policy including a control rule to be applied to a mobile terminal 131 is created by the policy creating part 107 based on the operation by the administrator 102, and is stored in the policy table 112.

The terminal information receiving part 109 of the management server 101 acquires terminal information such as identification information and positional information of each mobile terminal, a policy allocated thereto, and the current control state thereof from each mobile terminal 131 over the communication network 121, and stores the terminal information in the terminal information table 113.

To allocate a policy to a mobile terminal 131, the management server 101 selects a policy to be applied to the mobile terminal 131 from information defined in the policy table 112, and selects which mobile terminal 131 where the policy is to be applied from the information held in the terminal information table 113. The policy allocating part 108 associates the target policy with data of the target mobile terminal 131, after which the policy transmitting part 110 transmits information on the target policy to the mobile terminal 131 associated with the target policy via the network I/F 114. Accordingly, the policy is allocated to the mobile terminal 131.

After allocation of the policy, the terminal information receiving part 109 acquires terminal information indicating how the mobile terminal 131 is controlled, and the management server 101 manages the state of the mobile terminal 131 based on the terminal information. The display part 104 provides the administrator 102 with the managed states.

FIG. 1C is a block diagram illustrating the configuration of the mobile terminal 131 according to the first embodiment of this invention.

The mobile terminal 131 according to the first embodiment includes a CPU 150, a network I/F 149, an input/output I/F 139, a memory 140, and a storage area 146 which are connected to one another, and further includes a positional information acquiring part 145.

The CPU 150 is a processor that performs various processes in accordance with a program stored in the memory 140. A program for a terminal that is run by the CPU 150 is stored in the memory 140. A policy receiving part 141, a terminal information transmitting part 142, and a control status determining part 143 illustrated in FIG. 1C are program modules that constitute the terminal program or a part thereof. The processes that are performed by those parts are described later.

Terminal positional information 147, which is positional information of a mobile terminal 131 acquired by the positional information acquiring part 145, and allocated policy information 148 defining a policy allocated to this mobile terminal 131 by the management server 101 are stored in the storage area 146.

Like the memory 106 and the storage area 111 of the management server 101, the memory 140 and the storage area 146 may be achieved by any kind of storage device.

An operation part 133, a display part 134, an audio input part 135, an audio output part 136, an image information input part 137, and an image information output part 138 are connected to input/output I/F 139. The operation part 133 includes an input device, such as buttons and a touch panel, which is operated by the user 132. The display part 134 is an output device that outputs information to the user 132. For example, the display part 134 is an image display device that provides the user 132 with a GUI screen for operating the mobile terminal 131.

As described later, the display part 134 may display an area or the like defined by a policy over a map in a superimposed fashion. In this case, map information (not shown) is stored in the memory 140 or the storage area 146.

The audio input part 135 receives an input of audio information input from outside the mobile terminal 131. For example, the audio input part 135 may include a microphone that converts an audio signal to an electric signal, and a processing circuit or the like that converts the electric signal to audio data. External sounds of the mobile terminal 131 can be recorded by storing audio information acquired by the audio input part 135 in the memory 140 or the storage area 146.

The audio output part 136 outputs audio information. For example, the audio output part 136 may include a processing circuit, amplifier, and speaker for outputting audio data as sounds.

The image information input part 137 receives an input of image information such as a still image or a moving image input from outside the mobile terminal 131. For example, the image information input part 137 may include a camera and image processing circuit for picking up a still image or a moving image. The image information acquired by the image information input part 137 is stored in the memory 140 or the storage area 146, and thus an image outside the mobile terminal 131 can be captured.

The image information output part 138 outputs image information. For example, the image information output part 138 may include a display screen or the like to output image information. The display part 134 may be used as the image information output part 138.

The audio input part 135 and the image information input part 137 are an example of an information input part for acquiring a predetermined type of information (e.g., audio information and image information) from outside the mobile terminal 131, and the mobile terminal 131 may include another kind of information input part. When information acquired by such an information input part includes information access to which should be restricted, such as confidential information, the mobile terminal 131 can be a source for leaking the confidential information or the like if holding the information. When a policy allocated to the mobile terminal 131 includes a control rule relating to a function of the information input part, controlling the function based on such a control rule can prevent leakage of confidential information or the like.

It should be noted that prevention of leakage of confidential information or the like is just an example of an object of this invention. This invention can be applied widely when restrictive use of an arbitrary function of a mobile terminal 131 is set in association with a geographical area. This prevents unauthorized use or the like of the mobile terminal 131.

Information input by each information input part is handed to the internal processing of the mobile terminal 131 via the input/output I/F 139.

The positional information acquiring part 145 acquires positional information (specifically, positional coordinate information) of the mobile terminal 131 based on information transmitted from the positional information transmitting part 144, and holds the positional information as the terminal positional information 147. The positional information transmitting part 144 is a device or facility or the like that transmits information needed for the positional information acquiring part 145 to acquire positional information. For example, the positional information transmitting part 144 is a Global Positioning System (GPS) satellite or a wireless base station or the like installed indoor or outdoor. In this case, the positional information acquiring part 145 acquires positional information of the mobile terminal 131 through a positioning technology like the GPS based on the WGS-84 coordinate system, and may acquire positional information in further combination of a gyro sensor or the like.

The policy receiving part 141 of the mobile terminal 131 receives policy information allocated by the management server 101 via the network I/F 149. Thereafter, the mobile terminal 131 holds the received policy information as the allocated policy information 148 in the storage area 146. The control status determining part 143 determines the control state of the mobile terminal 131 based on the held positional information and the held policy information, and controls the functions of the individual parts (e.g., the audio input part 135 and image information input part 137) of the mobile terminal 131 based on the control state.

Further, the terminal information transmitting part 142 of the mobile terminal 131 regularly transmits the information of the mobile terminal 131 itself (e.g., latest positional information and control state or the like) to the management server 101. When receiving this information, the terminal information receiving part 109 of the management server 101 updates the terminal information table 113 based on the information.

FIG. 2 is an explanatory diagram of the relation between an area defined by a policy and an error in positional information acquired by the positional information acquiring part 145 according to the first embodiment of this invention.

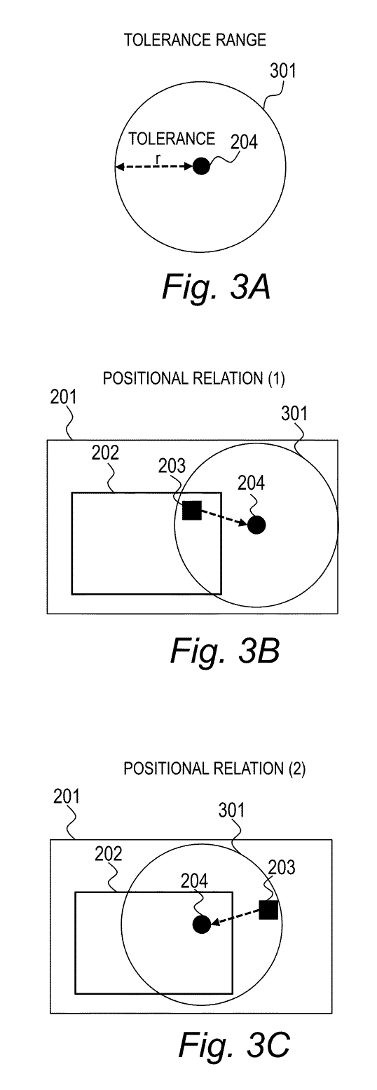

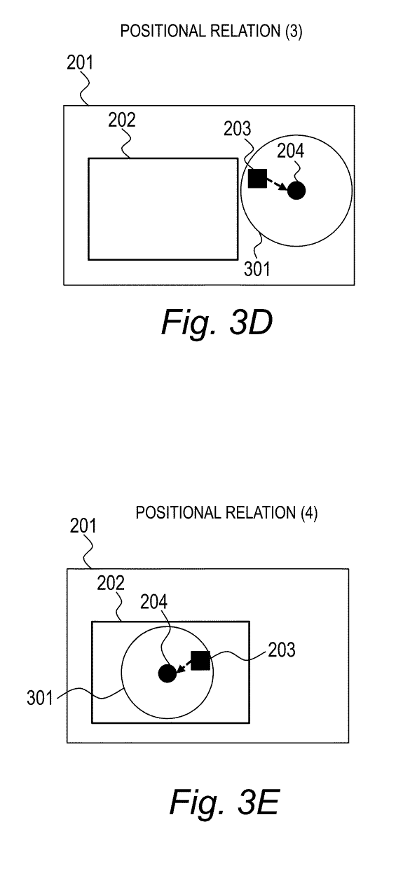

In FIG. 2, an area 202 is a geographical area to which a control rule of inhibiting the use of a camera function of the image information input part 137 is applied. The area 202 and the control rule to be applied thereto are defined by one policy (referred to as “policy 2” in the descriptions of FIG. 2 and FIGS. 3A to 3E). A typical example of the area 202 is an area where confidential information or the like is handled, and the policy 2 is defined to prevent leakage of confidential information or the like.

By contrast, an area 201 is a geographical area surrounding the area 202 to which a control rule to permit the use of the camera function is applied. The area 201 and the control rule to be applied thereto are defined by another policy (referred to as “policy 1” in the descriptions of FIG. 2 and FIGS. 3A to 3E). A typical example of the area 201 is an area where access to confidential information or the like is not expected, such as public space where a lot of unspecified people can freely enter and leave.

In this example, the control rule of the policy 2 that inhibits the use of the camera function needs to be applied to the mobile terminal 131 located at positional coordinates 203 within the area 202. Because positional coordinate information acquired by the positional information acquiring part 145 includes an error, however, the positional information acquiring part 145 of the mobile terminal 131 located at positional coordinates 203 may actually acquire positional coordinates 204 of the area 201, not those of the area 202. In this case, the control rule of the policy 1 that permits the use of the camera function is applied. As apparent from the above, a wrong control rule which the administrator does not expect may be applied to the mobile terminal 131 due to an error in positional information, which may lead to an undesirable consequence of leakage or the like of confidential information.

Application of the control rule of a policy is also referred to simply as application of the policy, and that policy is also referred to as applied policy in the following description.

In this embodiment, an error which may be included in positional information acquired by the positional information acquiring part 145 is set as “tolerance,” and a control rule is applied in consideration of the tolerance to overcome the above-mentioned problem. A description is given of the tolerance referring to FIGS. 3A to 3E.

FIG. 3A is an explanatory diagram of the tolerance of positional information acquired by the positional information acquiring part 145 according to the first embodiment of this invention.

When the distance between positional coordinates 204 acquired by the positional information acquiring part 145 and actual positional coordinates 203 of the mobile terminal 131 is estimated to be equal to r or less (i.e., the tolerance is r) from the conditions such as the characteristics of the positional information acquiring part 145 and the environment of the mobile terminal 131, the circular range with a radius r about the positional coordinates 204 is a tolerance range 301. In other words, when the positional information acquiring part 145 acquires the positional coordinates 204, the range where the mobile terminal 131 can actually be located is the tolerance range 301.

FIGS. 3B to 3E are explanatory diagrams of first to fourth examples of the relation between the positional coordinates 204 acquired by the positional information acquiring part 145 and the actual positional coordinates 203 of the mobile terminal 131 according to the first embodiment of this invention.

FIG. 3B illustrates an example where the positional coordinates 204 acquired by the positional information acquiring part 145 is included in the area 201, and the tolerance range 301 includes both part of the area 201 and part of the area 202. In this case, the actual positional coordinates 203 of the mobile terminal 131 may be included in the area 201, but may be included in the area 202 as illustrated in FIG. 3B.

FIG. 3C illustrates an example where the positional coordinates 204 acquired by the positional information acquiring part 145 is included in the area 202, and the tolerance range 301 includes both part of the area 201 and part of the area 202. In this case, the actual positional coordinates 203 of the mobile terminal 131 may be included in the area 202, but may be included in the area 201 as illustrated in FIG. 3C.

FIG. 3D illustrates an example where the positional coordinates 204 acquired by the positional information acquiring part 145 is included in the area 201, and the tolerance range 301 includes only part of the area 201. In other words, in this example, the actual positional coordinates 203 of the mobile terminal 131 are surely included in the area 201, and are unlikely to be included in the area 202.

FIG. 3E illustrates an example where the positional coordinates 204 acquired by the positional information acquiring part 145 is included in the area 202, and the tolerance range 301 includes only part of the area 202.

In other words, in this example, the actual positional coordinates 203 of the mobile terminal 131 are surely included in the area 202, and are unlikely to be included in the area 201.

Because it is possible to specify in which one of the areas 201 and 202 the mobile terminal 131 is actually present in the cases of FIGS. 3D and 3E, a control rule to be applied to the mobile terminal 131 can be correctly specified in accordance with the policy 1 and the policy 2 corresponding to the respective areas. Accordingly, information leakage or the like can be prevented. In the cases of FIG. 3B and 3C, however, it is not possible to specify in which one of the areas 201 and 202 the mobile terminal 131 is actually present, and hence a control rule to be applied to the mobile terminal 131 cannot be specified by merely referring to the control rules defined by the respective policies and the areas to which the control rules are applied. In this embodiment, exclusive control based on the priority of policies or merging of policies is carried out to specify a control rule that is to be applied in such a case. Those processes are described later.

In the above-mentioned examples, the area 202 and the area 201 do not overlap each other. In other words, the area 201 is an area obtained by removing the area inside the rectangular contour line of the area 202 from the area inside the rectangular contour line of the area 201 illustrated in FIG. 2 or the like. However, a plurality of areas that are defined by a plurality of policies may actually overlap one another. When the area 201 and the area 202 overlap each other, for example, the area inside the rectangular contour line of the area 202 is the area 202 as well as part of the area 201. In such a case, the actual positional coordinates 203 of the mobile terminal 131 are included in both the area 201 and the area 202 in the example of FIG. 3E, and hence a control rule cannot be specified as in the case of, for example, FIG. 3B.

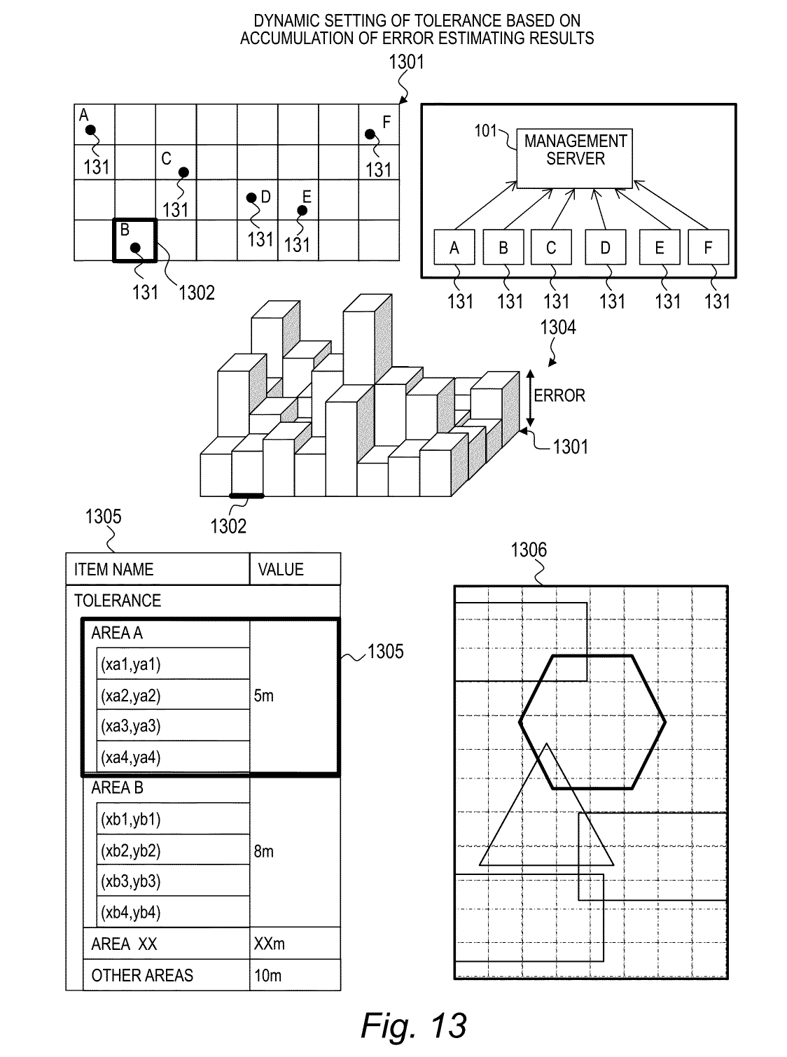

In addition, the tolerance r may be a fixed value, but may be a variable value which is determined depending on various conditions. An example where the tolerance r is variable is described later referring to FIG. 13.

Next, the contents of the policy table 112 are described referring to FIGS. 4A to 4C.

FIGS. 4A to 4C are explanatory diagrams of tables 401 to 403 included in the policy table 112 according to the first embodiment of this invention.

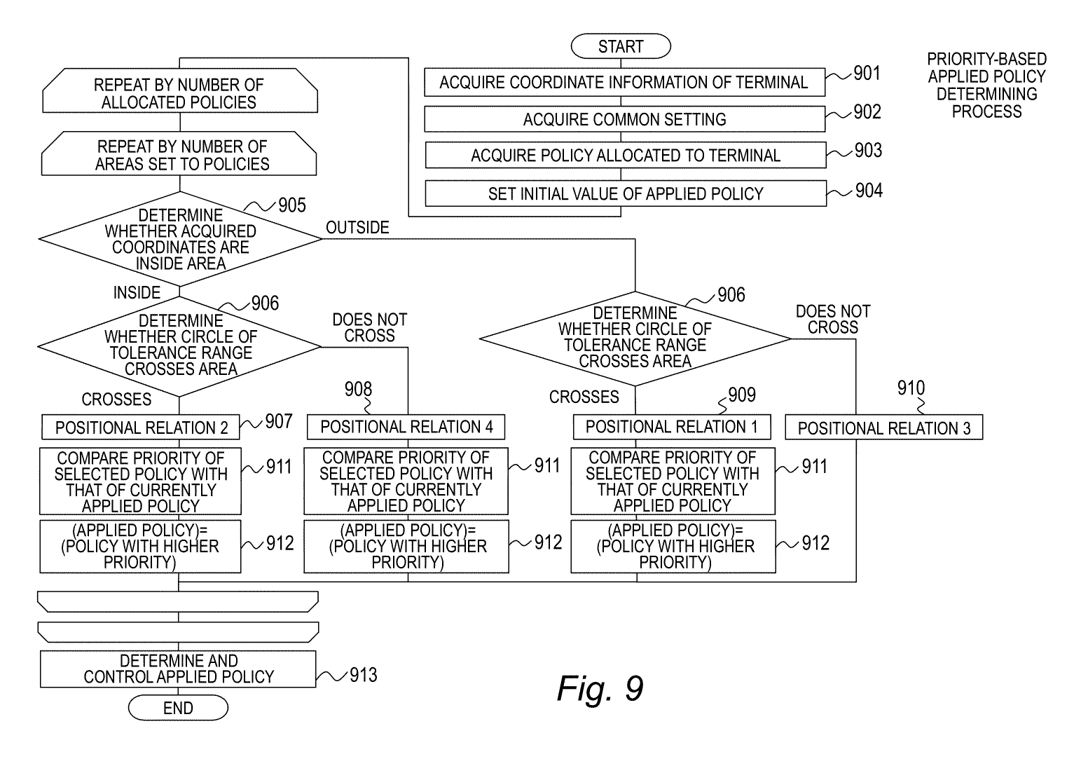

The table 401 is information associating a policy name 401A which identifies each policy with a priority 40B given to each policy. In the example of FIG. 4A, “policy A,” “policy B,” and “default policy” are held as the policy name 401A, and “1,” “2” and “3” are held as the priorities 401B respectively corresponding to the policies. A greater value of the priority 401B means that the priority is lower. The priority-based process is described later referring to FIG. 9 and other drawings.

Each of the policy A and the policy B defines at least one geographical area, and a control rule to be applied to the area. The example of the policy A is described later referring to FIG. 4C. By contrast, the default policy is applied when neither policy is applied to the mobile terminal 131. Because this default policy is applied regardless of a geographical area, the default policy does not include information that defines a geographical area (in other words, the default policy includes information defining a control rule that is to be applied to every geographical area). In addition, the default policy is given a lowest priority.

The table 402 includes information that defines a value to be applied in common to every mobile terminal 131 regardless of the policy (hereinafter also referred to as “common setting”). Specifically, the table 402 includes an item name 402A of a value to be defined, and a value 402B to be defined. In the example of FIG. 4B, a value “10 m” corresponding to an item name “tolerance” is held. This indicates that the tolerance r illustrated in FIG. 3A is 10 meters. Although FIG. 4B illustrates an example where only one tolerance is defined, for example, a plurality of tolerances to be applied to a plurality of arbitrary geographical areas may be defined.

Further, in the example of FIG. 4B, “exclusion based on priority” which is a value corresponding to an item name “control between policies” is held. This indicates that when a plurality of policies may be applied to the mobile terminal 131 as in the examples of FIGS. 3B and 3C, for example, a policy selection rule of exclusively selecting one policy based on the priority is applied. It should be noted that “merge” or the like may be held beside “exclusion based on priority” as a value corresponding to the item name “control between policies.” This case is described later.

The table 403 shows examples of geographical ranges and control rules that are defined by the policy A. In the example of FIG. 4C, “range A,” “range B,” “camera,” “voice record,” “voice input,” etc. are held as setting items 403A.

Each of the setting items “range A” and “range B” is associated with at least three coordinates held in the value 403B. For example, the “range A” is associated with coordinates 1 (xa1, ya1) to coordinates 4 (xa4, ya4).

This indicates that the range A is a rectangular range A_404 having vertices at those four coordinates. The “range B” is associated with coordinates 1 (xb1, yb1) to coordinates 6 (xb6, yb6). This indicates that the range B is a hexagonal range B_405 having vertices at those six coordinates.

The geographical range may be defined by a method other than the above-mentioned method. For example, a circular geographical range may be defined by the coordinates of the center of the circle and the radius thereof.

The setting items “camera,” “voice record,” and “voice input” are items for control rules that are defined for the functions of the information input parts such as the image information input part 137 and the audio input part 135, and values representing whether those functions are to be restricted are held as the values 403B corresponding to those items. The restriction of a function may be inhibition of the use of that function, but may be restriction on parameters or the like that are applied to the function (e.g., restriction on the resolution of a camera, the tone of a voice record or the recording time thereof, or the like).

With the policy A defined, when the mobile terminal 131 is specified to be located in any one of the range A and the range B, a control rule which is defined in association with the setting items “camera,” “voice record,” and “voice input” is applied to the mobile terminal 131.

Each policy may include items other than those given above as setting items. In addition, each policy may include information defining a single geographical area, may include information defining at least one three geographical areas, or may not include information defining a geographical area. When a policy does not include information defining a geographical area, a control rule defined by that policy is applied to every geographical area (in other words, regardless of where the mobile terminal 131 is located).

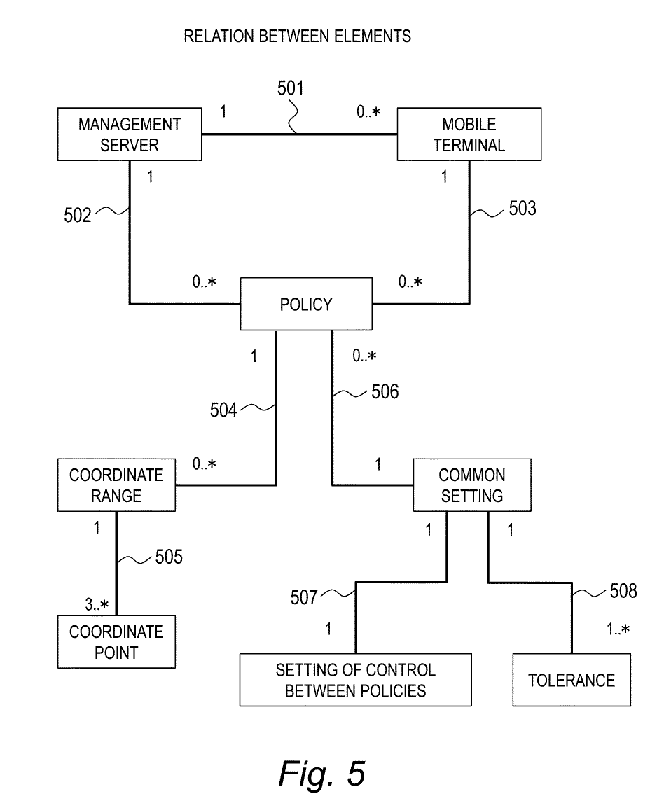

FIG. 5 is an explanatory diagram of the relation among components constituting the first embodiment of this invention.

A single management server 101 manages an arbitrary number of mobile terminals 131. The single management server 101 also holds an arbitrary number of policies. An arbitrary number of policies are allocated to a single mobile terminal 131. One policy includes definitions of an arbitrary number of geographical areas (coordinate ranges), and a single geographical area is expressed by a set of at least three coordinate points. In addition, a single common setting is made in connection to an arbitrary number of policies. The single common setting includes one definition relating to control between policies, and at least one definition relating to tolerance.

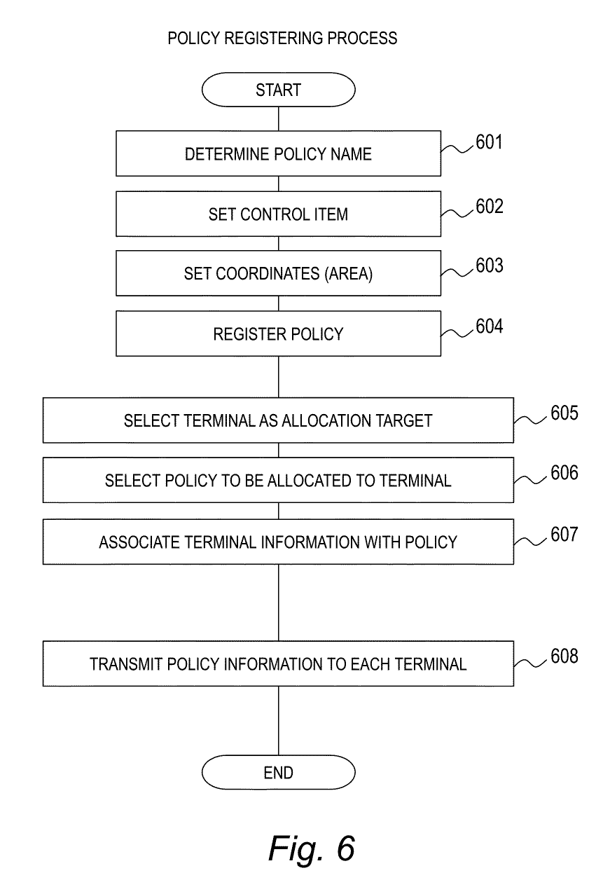

Next, a process of creating a policy is described referring to FIGS. 6 to 8.

FIG. 6 is a flowchart illustrating a policy registering process that is performed by the management server 101 according to the first embodiment of this invention.

First, the administrator 102 determines a policy name, and inputs the policy name to the management server 101 via the operation part 103 (Step 601). Thereafter, setting, selection, inputting of information and the like which are made to the management server 101 by the administrator 102 in the individual steps of FIG. 6 are performed by the administrator 102 operating the operation part 103.

Next, the administrator 102 sets a control item (Step 602). Specifically, the administrator 102 inputs a value representing “limited” or “not limited” corresponding to, for example, the setting items “camera,” “voice record,” “voice input,” etc. of FIG. 4C to the management server 101.

Then, the administrator 102 sets the coordinates representing a geographical area (Step 603). Specifically, the administrator 102 inputs the coordinate values corresponding to the “range A” and “range B” of FIG. 4C to the management server 101.

Next, the administrator 102 checks the settings up to Step 603, and commits a policy which is created by the setting. The policy creating part 107 of the management server 101 creates a policy in accordance with the settings up to Step 603, and registers the policy in the policy table 112 (Step 604).

Next, the administrator 102 selects a mobile terminal 131 to which the policy is to be allocated (Step 605). The administrator 102 may select a plurality of mobile terminals 131.

Next, the administrator 102 selects a policy to be allocated to the selected mobile terminal 131 (Step 606). The administrator 102 may select a plurality of policies.

The policy allocating part 108 of the management server 101 associates the selected mobile terminal 131 with the selected policy (Step 607). Information which associates the mobile terminal 131 and the policy with each other is held in the storage area 111 of the management server 101.

Then, the policy transmitting part 110 of the management server 101 transmits information on policies to the individual mobile terminals 131

(Step 608). At this time, the policy transmitting part 110 transmits at least information on the policies allocated to the mobile terminals 131 (e.g., table 403) and the common setting (e.g., table 402). The policy receiving part 141 of each mobile terminal 131 holds the information on the policy received from the management server 101 as allocated policy information 148.

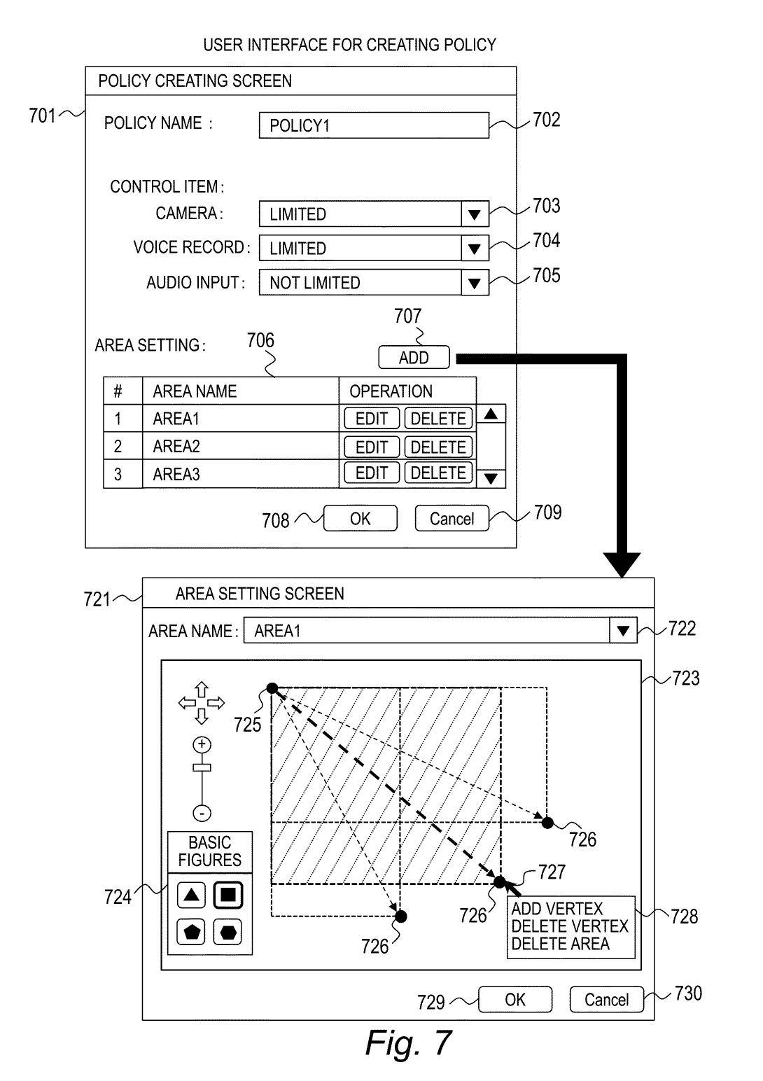

FIG. 7 is an explanatory diagram of screens which are displayed when the management server 101 according to the first embodiment of this invention performs the policy registering process.

The policy registering process illustrated in FIG. 6 may be performed via the GUI provided by the display part 104 of the management server 101. FIG. 7 illustrates one example of the GUI screens. The following describes one example of a procedure of executing the policy registering process referring to FIG. 7.

When the policy registering process starts, the display part 104 displays a policy creating screen 701 first. The policy creating screen 701 includes a policy name setting filed 702, one or more control item setting fields 703 to 705, an area setting field 706, an ADD button 707, an OK button 708, and a CANCEL button 709.

In Step 601, the administrator 102 inputs a policy name to the policy name setting filed 702.

In Step 602, the administrator 102 inputs a control rule corresponding to at least one control item to the control item setting field. For example, the administrator 102 inputs “limited,” “limited,” and “not limited” corresponding to control items “camera,” “voice record,” and “voice input” to the control item setting fields 703 to 705, respectively. The control item setting fields 703 to 705 may be provided with a pull-down list for selecting any one of a plurality of control rules such as “limited” or “not limited.”

In Step 603, the administrator 102 operates the area setting field 706 to add, edit, or delete a geographical area to which a control rule for a policy is applied.

For example, the administrator 102 can add a new geographical area by operating an area setting screen 721 (to be described later), which is displayed by operating the ADD button 707. The area setting field 706 includes display of an area name for identifying each of at least one geographical area set, and an EDIT button and a DELETE button which correspond to each area name. The administrator 102 can edit a geographical area already set (e.g., change coordinate value defining the geographical area) by operating the EDIT button corresponding to each area name. At this time, the area setting screen 721 may be used. Alternatively, the administrator 102 can delete a geographical area already set by operating the DELETE button corresponding to each area name.

When the administrator 102 operates the OK button 708 in Step 604, addition, edition, or deletion of a geographical area is committed in accordance with the states of the area setting field 706 and the like which have been input up to that point of time. On the other hand, when the administrator 102 operates the CANCEL button 709, inputs to the area setting field 706 and the like which have been input up to that point of time are canceled.

The display part 104 displays the area setting screen 721 when the administrator 102 operates the ADD button 707 and the EDIT button in the area setting field. The area setting screen 721 includes an area name setting field 722, an area coordinates setting field 723, an OK button 729, and a CANCEL button 730.

An area name identifying a geographical area which is to be added or edited is input to the area name setting field 722. For example, when the administrator 102 operates the ADD button 707, an empty area name setting field 722 may be displayed so that the administrator 102 inputs a new area name to the empty area name setting field 722. The administrator 102 inputs a coordinate value defining a new geographical area by operating the area coordinates setting field 723.

A map is displayed as the background of the area coordinates setting field 723 so that the administrator 102 can input coordinates defining a geographical area with an arbitrary shape on the map. For example, the area coordinates setting field 723 includes a basic figure selection field 724 to select a figure displayed therein, such as a triangle, a quadrangle, a pentagon, or a hexagon. Further, when a range for displaying that figure is specified on the area coordinates setting field 723, a figure similar to the selected figure is displayed in the specified range in the area coordinates setting field 723. The administrator 102 can define a geographical area with an arbitrary shape by moving vertices of the displayed figure.

When the administrator 102 selects a quadrangle in the basic figure selection field 724, and further specifies a start point 725 and an end point 726 in the area coordinates setting field 723, for example, a quadrangle with a maximum size within the range of a quadrangle whose diagonal line is a line connecting the start point 725 and the end point 726 is defined as a geographical area. When a triangle is selected in the basic figure selection field 724, a triangle with a maximum size within the range of a quadrangle whose diagonal line is a line connecting the start point 725 and the end point 726 is defined.

FIG. 7 illustrates three end points 726, and a quadrangle with an arbitrary aspect ratio and an arbitrary size can be specified by specifying an arbitrary one of the end points 726. It should be noted that the start point 725 and the end point 726 may be set in a position where the administrator 102 has started dragging a mouse cursor 727 and a position where the administrator 102 has stopped dragging the mouse cursor 727.

The area setting screen 721 may further include a context menu 728 which is displayed in connection to the mouse cursor 727. The context menu 728 displays items, such as “ADD VERTEX,” “DELETE VERTEX,” and “DELETE AREA,” for editing the shape of a geographical area displayed on the area coordinates setting field 723. The administrator 102 can add a vertex to the shape of a geographical area, delete an existing vertex, or delete the entire geographical area already input by selecting those items.

When the administrator 102 operates the OK button 729, a geographical area input by that point of time is committed. When the administrator 102 operates the CANCEL button 730, inputs on a geographical area up to that point of time are canceled.

When the administrator 102 operates an EDIT button corresponding to any one of the area names in the area setting field 706, the area name may be displayed in the area name setting field 722. At this time, the shape of the geographical area with this area name which has already been set is displayed in the area coordinates setting field 723. The administrator 102 may edit the shape through the above-mentioned method. Further, the administrator 102 can define a new geographical area using the definition of an existing geographical area by changing the area name displayed in the area name setting field 722 to a new area name.

Alternatively, a pull-down menu (not shown) containing the area names of geographical areas already defined may be displayed when the administrator 102 operates the ADD button 707 to display an empty area name setting field 722, and further operates a menu display button at the right-hand end of the area name setting field 722. When the administrator selects any one of the geographical areas from the pull-down menu, the shape of the selected geographical area is displayed in the area coordinates setting field 723. Thereafter, a new geographical area can be defined using the definition of an existing geographical area by changing the area name in the above-mentioned manner and editing the shape of a geographical area as needed.

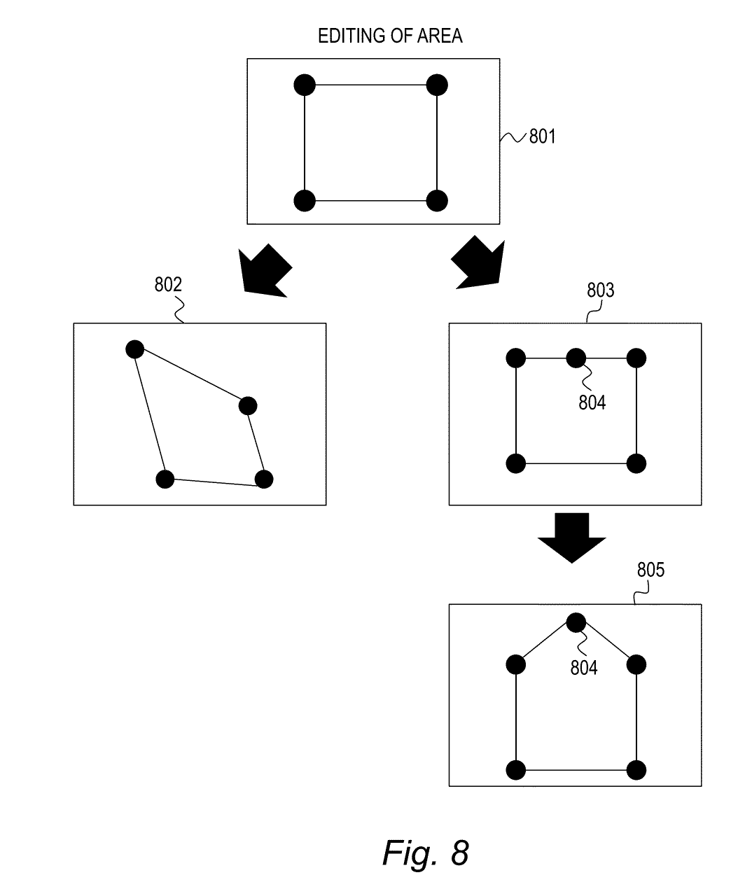

FIG. 8 is an explanatory diagram of edition of the shape of a geographical area by the management server 101 according to the first embodiment of this invention.

For example, the administrator 102 can draw a rectangle by selecting a quadrangle from the basic figure selection field 724 (FIG. 801). Further, the administrator 102 can select and move an arbitrary vertex of the rectangle using the mouse cursor 727 to change the rectangle (FIG. 802). Further, the administrator 102 may also move the entire selected rectangle in parallel using the mouse cursor 727.

Alternatively, the administrator 102 may select “ADD VERTEX” from the context menu 728 and specify an arbitrary position on an arbitrary side of a quadrangle using the mouse cursor 727 to add a new vertex 804 in that position (FIG. 803). Further, the administrator 102 may move the added vertex 804 using the mouse cursor 727. In this manner, the administrator 102 can create a polygon whose geographical area defined by a policy has an arbitrary shape.

FIG. 9 is a flowchart illustrating an applied policy determining process that is performed by the mobile terminal 131 according to the first embodiment of this invention.

For example, execution of the applied policy determining process illustrated in FIG. 9 may start in accordance with a predetermined schedule (e.g., regularly), may start in response to occurrence of a predetermined event (e.g., acquisition of new positional coordinate information by the positional information acquiring part 145), may start in response to an explicit instruction from the user 132 or the like, or may start in response to an explicit instruction from the administrator 102 transmitted from the management server 101.

First, the control status determining part 143 of a mobile terminal 131 acquires positional coordinate information of the mobile terminal 131 included in the terminal positional information 147 stored in the storage area 146 (Step 901). The terminal positional information 147 includes at least the latest positional coordinate information of the mobile terminal 131 acquired by the positional information acquiring part 145, and hence when the interval at which the positional information acquiring part 145 acquires positional coordinates is sufficiently short, the latest positional coordinates can be used approximately as the current positional coordinates of the mobile terminal 131.

Next, the control status determining part 143 of the mobile terminal 131 acquires common setting from the allocated policy information 148 (Step 902). The common setting includes information on the tolerance and control between policies as shown in FIG. 4B. The following describes a case where control between policies is “exclusion based on priority.”

Then, the control status determining part 143 of the mobile terminal 131 acquires information (e.g., table 403) of a policy allocated to the mobile terminal 131 from the allocated policy information 148 (Step 903).

Then, the control status determining part 143 sets an initial value for an applied policy (Step 904). The initial value for an applied policy is an applied policy that is determined by the applied policy determining process performed previously, and is a default policy when the applied policy determining process is performed for the first time.

Next, the control status determining part 143 selects one of a plurality of policies allocated to this mobile terminal 131, and further selects one geographical area defined by the selected policy (one of a plurality of geographical areas when the plurality of geographical areas are defined). Then, the control status determining part 143 determines whether the selected geographical area contains the positional coordinates acquired in Step 901, (Step 905).

The determination in Step 905 can be achieved by an arbitrary one of known methods such as determination based on the number of times a half line having the positional coordinates acquired in Step 901 as the start point crosses the contour line of the selected geographical area, or determination based on the sum of the angles defined by the positional coordinates acquired in Step 901 and coordinate points on the contour line.

Next, the control status determining part 143 determines whether the contour line of a tolerance range having the positional coordinates acquired in Step 901 as the center (referred to as “this tolerance range” herein) crosses the contour line of the selected geographical area (Step 906). This determination can be achieved by an arbitrary known method for acquiring the intersection of a line segment or a line and a circle.

Crossing of the contour line of this tolerance range with the contour line of the selected geographical area means that part of this tolerance range may overlap at least part of the selected geographical area, in other words, the actual location of the mobile terminal 131 may be included in the selected geographical area.

When it is determined that the positional coordinates are included in the selected geographical area in Step 905, and it is determined that the contour line of this tolerance range crosses the contour line of the selected geographical area in Step 906, it is determined that the positional relation between this tolerance range and each geographical area is similar to the one illustrated in FIG. 3C (Step 907). It should be noted that in this example, the area 202 is equivalent to the selected geographical area, and the area 201 is equivalent to a geographical area other than the selected geographical area (the same is also true of Steps 908 to 910 to be described later). The actual positional coordinates 203 of the mobile terminal 131 may be included in the area 202.

In this case, the control status determining part 143 compares the priority of the selected policy with the priority of the current applied policy (Step 911). Then, the control status determining part 143 determines the selected policy or the current applied policy whichever has a higher priority as a new applied policy (Step 912).

When it is determined that the positional coordinates are not included in the selected geographical area in Step 905, and it is determined that the contour line of this tolerance range crosses the contour line of the selected geographical area in Step 906, it is determined that the positional relation between this tolerance range and the selected geographical area is similar to the one illustrated in FIG. 3B (Step 909). It should be noted that the actual positional coordinates 203 of the mobile terminal 131 may be included in the area 201.

In this case, the control status determining part 143 executes Steps 911 and 912 to determine the selected policy or the current applied policy whichever has a higher priority as a new applied policy.

When it is determined that the positional coordinates are included in the selected geographical area in Step 905, and it is determined that the contour line of this tolerance range does not cross the contour line of the selected geographical area in Step 906, it is determined that the positional relation between this tolerance range and the selected geographical area is similar to the one illustrated in FIG. 3E (Step 908). This means that this tolerance range entirely overlaps at least part of the selected geographical area, in other words, the actual location of the mobile terminal 131 is surely included in the selected geographical area. In this case, the selected policy can be determined as a final applied policy unless the geographical area is set redundantly. However, redundant setting of a geographical area is actually possible, and hence the control status determining part 143 performs Steps 911 and 912 to determine the selected policy or the current applied policy whichever has a higher priority as a new applied policy (Step 914).

When any one of the policies is determined as a new applied policy in Step 912 while Steps 905 to 912 are repeatedly performed by the number of policies and the number of geographical areas set in each policy, the new applied policy is treated as “current applied policy” in Step 911 that is to be performed next time.

When it is determined that the positional coordinates are not included in the selected geographical area in Step 905, and it is determined that the contour line of this tolerance range does not cross the contour line of the selected geographical area in Step 906, it is determined that the positional relation between this tolerance range and the selected geographical area is similar to the one illustrated in FIG. 3D (in other words, this tolerance range does not overlap the selected geographical area at all, and the actual location of the mobile terminal 131 is unlikely to be included in the selected geographical area) (Step 910). In this case, the control status determining part 143 does not perform Steps 911 and 912 (in other words, the current applied policy is not changed).

The control status determining part 143 repeatedly performs Steps 905 to 912 until all the policies allocated to the mobile terminal 131 and all of the defined geographical areas are selected, and the processes of Steps 905 to 912 are terminated.

The control status determining part 143 determines, as a final applied policy, the applied policy obtained when the processes of Steps 905 to 912 are terminated for all the policies allocated to the mobile terminal 131 and all of the defined geographical areas. The mobile terminal 131 controls the functions of the information input parts such as the audio input part 135 and the image information input part 137 based on the control rule defined by the determined applied policy (Step 913).

There may be a case where the tolerance range 301 need not be considered, e.g., when the tolerance r (FIG. 3A) is sufficiently small, or when nothing matters even when a wrong control rule is applied due to an error in positional information. In such a case, the process of FIG. 9 is performed under the condition of tolerance r=0. In this case, it is always determined as “not crossing” in Step 906. When it is determined, as a consequence, that the positional coordinates acquired in Step 901 are included in the selected geographical area, the selected policy is determined as a new applied policy. When it is determined that the positional coordinates acquired in Step 901 are not included in the selected geographical area, on the other hand, the applied policy is not changed. When it is determined that the positional coordinates acquired in Step 901 are included in a plurality of geographical areas defined by a plurality of policies (in other words, those geographical areas are redundantly set), one of the plurality of policies which has a highest priority is determined as a final applied policy.

As described above referring to FIGS. 3B to 3E, there may be a case where part of this tolerance range overlaps at least part of any one of geographical areas, and another part of this tolerance range overlaps at least part of another one of geographical areas. When a plurality of geographical areas are redundantly set, this tolerance range may further partly or entirely overlap a plurality of geographical areas. When all of the probable modes of redundancy as described above are expressed as “the tolerance range at least partly overlaps at least one geographical area defined by at least one policy,” through execution of the process illustrated in FIG. 9, the priorities of all the policies corresponding to all of the geographical areas that at least partly overlap the tolerance range (namely, all the geographical areas that may include the actual location of the mobile terminal 131) are compared with one another, and one of the policies which is given a highest priority is determined as a final applied policy. When there is only one corresponding geographical area, a policy corresponding to that geographical area is determined as a final applied policy.

The above has described the case where control between policies (table 402 of FIG. 4B) is “exclusion based on priority.” When control between policies is “merge,” however, processes different from those described above may be performed in Steps 911 and 912, and in order to enable the execution, the policy may include information different from the one described above.

For example, instead of giving the priority to each policy, the priority may be given for each of control rules included in each policy. In this case, the priorities of control rules of two policies are compared with each other for each control item in Step 911.

The following describes an example where a first policy and a second policy are compared with each other in Step 911. In this example, the first policy defines “limited,” “not limited,” and “not limited” as control rules respectively corresponding to the control items “camera,” “ voice record,” and “audio input,” and “1,” “2,” and “2” are respectively given to the control rules. By contrast, the second policy defines “not limited,” “limited,” and “limited” as control rules respectively corresponding to the control items “camera,” “voice record,” and “audio input,” and “2,” “1,” and “1” are respectively given to the control rules.

In this case, the control status determining part 143 compares the priorities of the control rules of the respective policies with each other for each control item, and creates a merged policy including the control rule which is given a higher priority. In the above-mentioned example, a merged policy whose control rule corresponding to any one of “camera,” “voice record,” and “audio input” is “limited” is generated, and is determined as a new applied policy.

When a control rule corresponding to one of the control items in the second policy is not defined, for example, a merged policy to which the control rule defined in the first policy is applied for that control item may be generated.

The policy-based control of the functions of the mobile terminal 131 as used in this embodiment may be used for various purposes. However, when this control is used to prevent leakage of confidential information, for example, a control rule that restricts the corresponding functions can be applied by priority even if the priority is not set to each control rule. Even when the priority is set to none of the control rules of the first policy and the second policy, for example, a merged policy whose control rule corresponding to any one of “camera,” “voice record,” and “audio input” is “limited” can be generated by applying the control rule that restricts the functions corresponding to the respective control items by priority.

Next, an example of the user interface provided to the user 132 by the mobile terminal 131 is described.

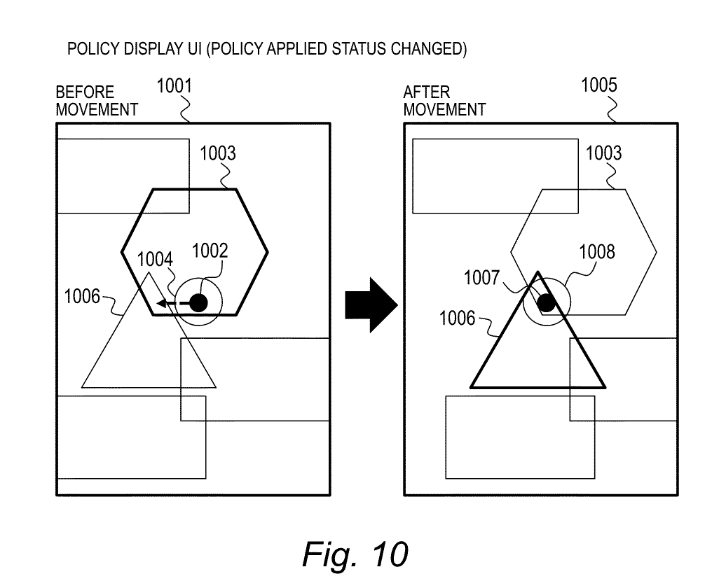

FIG. 10 is an explanatory diagram of the user interface provided by the mobile terminal 131 according to the first embodiment of this invention to display alteration of an applied policy.

Specifically, FIG. 10 illustrates an example of a screen displayed by the display part 134 of the mobile terminal 131 when the mobile terminal 131 (in other words, the user 132 carrying the mobile terminal 131) has moved so that the applied policy is changed.

A screen 1001 displayed by the display part 134 of the mobile terminal 131 before movement shows a map (not shown) as the background, and contour lines of a plurality of geographical areas superimposed over the map for display. An area 1003 is a geographical area defined by the current applied policy, and an area 1006 is a geographical area defined by another policy.

To distinguish the area 1003 for the applied policy from other areas (which are not the area for the applied policy), the area 1003 may be highlighted in a mode different from the modes for the other areas (e.g., by a line of a different thickness or a line of a different color). Further, information for identifying the applied policy (e.g., policy name) or information representing the contents of the applied policy (e.g., control rule to be applied) may be superimposed over the map for display.

Further, positional coordinates 1002 of the mobile terminal 131 acquired by the positional information acquiring part 145 and a tolerance range 1004 of the mobile terminal 131 are displayed on the screen 1001.

Positional coordinates 1007 of the mobile terminal 131 after movement acquired by the positional information acquiring part 145 and a tolerance range 1008 are displayed on a screen 1005 displayed by the display part 134 of the mobile terminal 131 after movement. The tolerance range 1008 after movement partly overlaps the areas 1003 and 1006. Because the priority of the policy for the area 1006 is higher than that of the policy for the area 1003 in this example, the policy for the area 1006 becomes a new applied policy. In this case, the highlighting of the area 1003 is stopped, and the area 1006 is newly highlighted.

When detecting a change in applied policy, the mobile terminal 131 may notify the user 132 of the change by voice, vibration, illumination, a string of characters within the screen, or the like.

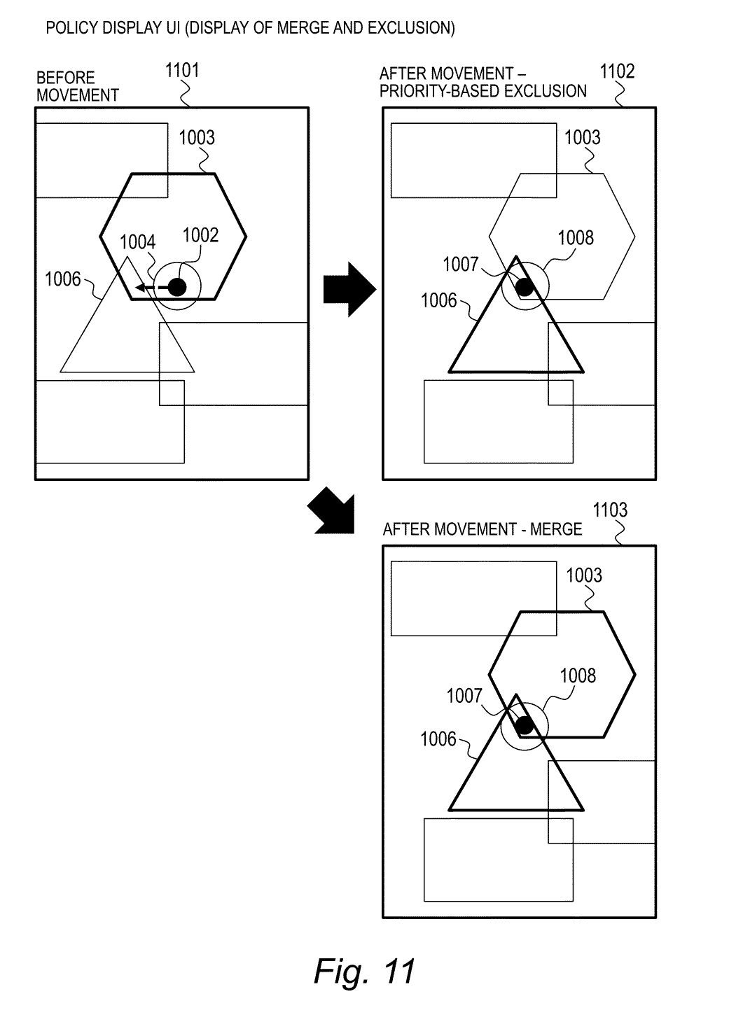

FIG. 11 is an explanatory diagram of the user interface that displays an applied policy in accordance with control between policies applied to the mobile terminal 131 according to the first embodiment of this invention.

Screens 1101 and 1102 illustrated in FIG. 11 are similar to the screens 1001 and 1005 of FIG. 10, respectively. The screen 1102 is displayed in a case where “exclusion based on priority” is set as control between policies, while a screen 1103 is displayed when “merge” is set. The two areas 1003 and 1006 defined by two policies to be merged are each highlighted on the screen 1103. It should be noted that because those areas are for different policies, the areas are displayed in different modes (e.g., by lines of different colors) to point out the fact.

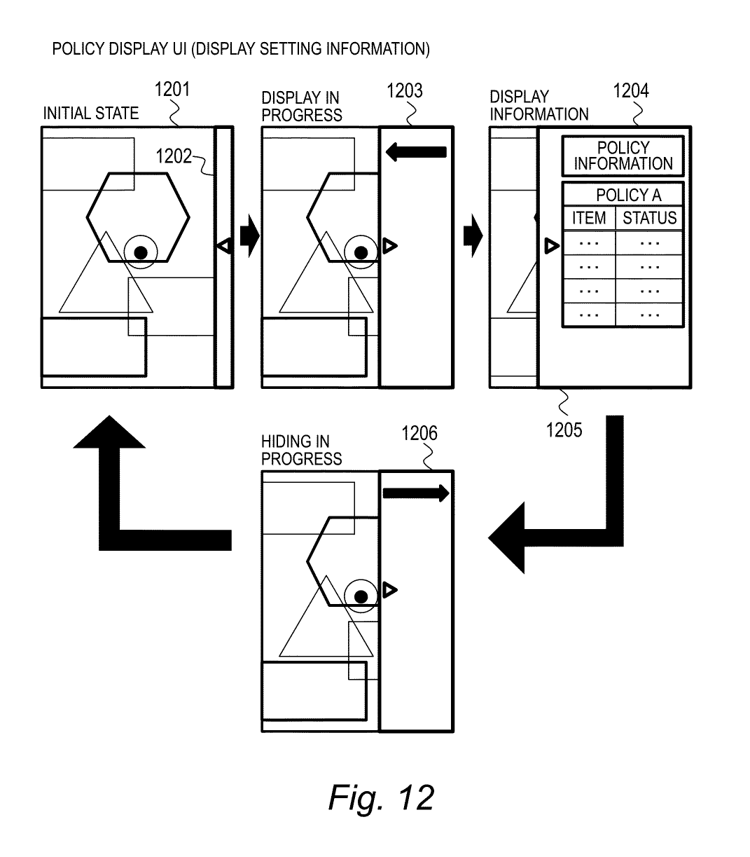

FIG. 12 is an explanatory diagram of the user interface that displays definition information of a policy allocated to the mobile terminal 131 according to the first embodiment of this invention.

An initial screen 1201 is the same as the screen 1001 except for a policy display control 1202 displayed at the right-hand end. When the user 132 manipulates (e.g., touches) the policy display control 1202 using the operation part 133, the area of the policy display control 1202 slides leftward to become larger (see an area 1203 which is being enlarged), and policy information 1204 is displayed in the enlarged area. This policy information 1204 may be similar to the table 403 of FIG. 4C.

Thereafter, when the user 132 manipulates a policy hiding control 1205, the area where policy information is displayed slides to become smaller (see an area 1206 which is being reduced), after which the screen returns to the initial screen 1201.

The above-mentioned interface is just an example, but actually, various interfaces can achieve information to be output to the user 132 and to be input from the user.

Next, dynamic setting of the tolerance of positional coordinate information acquired by the positional information acquiring part 145 is described referring to FIG. 13.

FIG. 13 is an explanatory diagram for dynamic setting of the tolerance according to the first embodiment of this invention.

A geographical area 1301 illustrated in FIG. 13 is divided into a plurality of smaller geographical areas 1302. Although FIG. 13 clearly illustrates only one geographical area 1302, individual segments included in the geographical area 1301 and separated in a lattice pattern are actually geographical areas 1302. Each of the geographical areas 1301 and 1302 is an area set independently of the geographical area defined by the policy. For example, the geographical area 1301 may be an area equivalent to the entire range where the mobile terminal 131 is locatable, and each geographical area 1302 may be a rectangular area created by segmenting the geographical area 1301 by a plurality of equidistant lines parallel to the longitude and a plurality of equidistant lines parallel to the latitude.

FIG. 13 illustrates six mobile terminals 131 identified by “A” to “F” each present in any one of the geographical areas 1302 of the geographical area 1301. Each mobile terminal 131 can move to an arbitrary geographical area 1302.

Each mobile terminal 131 acquires positional coordinate information using the positional information acquiring part 145, further estimates an error in positional coordinates at its own location, and transmits the estimation result to the management server 101. The estimation of an error in positional coordinates can be achieved by any known method.

The management server 101 determines the value of the tolerance for each geographical area 1302 by accumulating the estimated tolerance notified by the mobile terminal 131 for each geographical area 1302, and analyzing the accumulated results by a statistical approach. Although FIG. 13 illustrates only six mobile terminals 131, there are normally more mobile terminals 131, each of which moves into a geographical area 1301, and hence the management server 101 can accumulate estimated tolerance values in many (desirably all of) geographical areas 1302. A graph 1304 shows a variation in estimated tolerance value in each geographical area 1302 of the geographical area 1301, with the estimated tolerance values assigned to the ordinate.

When the tolerance value differs from one geographical area 1302 to another as described above, the policy table 112 needs to hold a tolerance 1305 for each geographical area 1302, not a single tolerance value common to the entire range as shown in the table 402 of FIG. 4B. The tolerance 1305 includes information that associates information identifying each geographical area 1302 with the value of the tolerance in each geographical area 1302. Each geographical area 1302 is identified by, for example, a name like “area A” and the coordinates of four vertices of a rectangle defining the contour of the geographical area 1302. In the example of FIG. 13, a value “5 m” is held for the tolerance corresponding to the “area A” and a value “8 m” is held for the tolerance corresponding to the “area B.”

Dynamic setting of the tolerance of the positional coordinate information is used, for example, as follows. The mobile terminal 131 regularly transmits the estimated tolerance value to the management server 101. The management server 101 reassesses the tolerance of each geographical area 1302 using the received estimated tolerance value. Accordingly, the level of an error which may occur due to various factors, such as weather, the position of a GPS satellite, and geography, can be reassessed continuously. This can ensure proper error setting based on the position to control the functions of the mobile terminal 131.

When different tolerances are set for the geographical areas 1302 individually, the display part 104 of the mobile terminal 131 can display the tolerance for each geographical area 1302 on a screen 1306 by, for example, color. Specifically, the display part 104 may superimpose colors or the like corresponding to the levels of the values of the tolerances over the individual rectangular areas or geographical areas 1302 segmented in a lattice pattern on the screen 1306.

The user 132 can know which area has a large tolerance based on what is displayed on the screen 1306. When the tolerance is large, the functions of the mobile terminal 131 whose user 132 is actually at a location where the functions of the mobile terminal 131 are not restricted are likely to be restricted under the influence of the control rule set for its neighboring geographical area. The user can know how much such restriction is likely to occur at the current location of the user or at a location where the user is going based on what is displayed on the screen 1306.

Although each geographical area 1302 is smaller than the geographical area 1003 or the like defined by the policy in the illustrated example of the screen 1306, the geographical area 1302 may be set larger than the geographical area defined by the policy.

### Second Embodiment

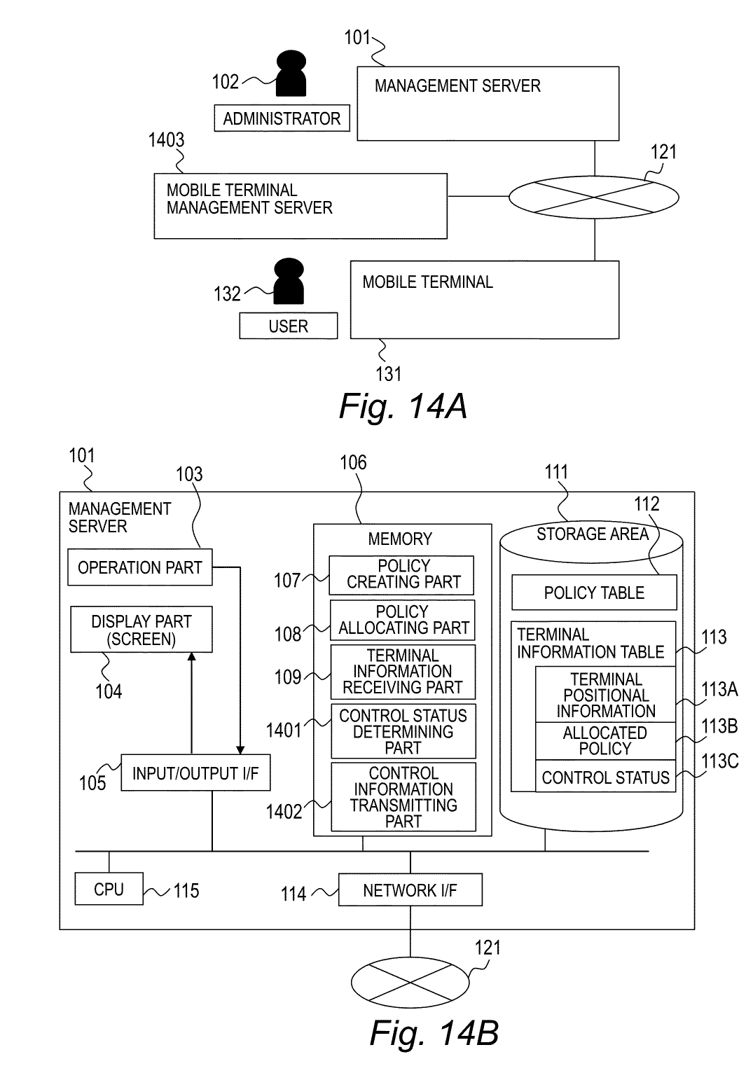

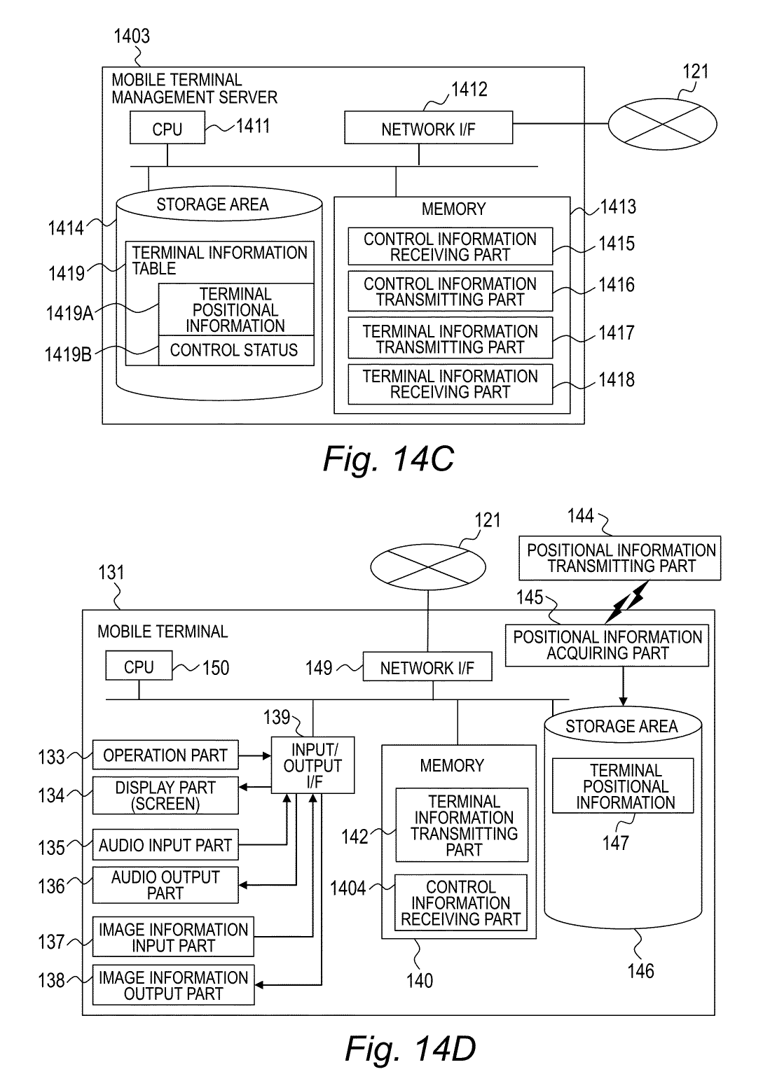

The following describes a second embodiment of this invention referring to FIGS. 14A to 14D. In the first embodiment, the management server 101 transmits allocated policy information to each mobile terminal 131, which determines a control rule to be applied based on the policy information and the acquired positional information. In the second embodiment, by contrast, the management server 101 determines control rule to be applied to each mobile terminal 131 based on the held policy information and the positional information acquired from each mobile terminal 131, and transmits the control rule to each mobile terminal 131. In addition, in the second embodiment, communication between the management server 101 and each mobile terminal 131 is carried out via a mobile terminal management server 1403 to be described later.

FIG. 14A is a block diagram illustrating the overall configuration of an information system according to the second embodiment of this invention.

The information system according to the second embodiment is the same as the information system according to the first embodiment except for the communication network 121 further coupled to the mobile terminal management server 1403 and the configurational differences in the management server 101 and the mobile terminal 131 which are described below.

FIG. 14B is a block diagram illustrating the configuration of the management server 101 according to the second embodiment of this invention.

The policy transmitting part 110 is not held in the memory 106 of the management server 101 according to the second embodiment, and a control status determining part 1401 and a control information transmitting part 1402 which are program modules that constitute the management server program or part thereof are held in the memory 106 instead. In addition, transmission and reception of information that are performed by the terminal information receiving part 109 and the control information transmitting part 1402 with respect to the mobile terminal 131 are carried out via the mobile terminal management server 1403. The management server 101 according to the second embodiment is the same as the management server 101 according to the first embodiment except for the above-mentioned point. Because the configurations other than that of the management server 101 according to the second embodiment have the same functions as those of the above-mentioned configurations illustrated in FIG. 1B and given the same reference numerals, their descriptions are omitted.

The policy registering process that is performed by the management server 101 is the same as the one performed by the management server 101 according to the first embodiment illustrated in FIG. 6 except for the omission of the procedure of transmitting created policy information to each mobile terminal 131 (Step 608).

The terminal information receiving part 109 in the management server 101 acquires terminal information such as identification information and positional information of each mobile terminal from each mobile terminal 131 via the communication network 121 and the mobile terminal management server 1403, and stores the terminal information in the terminal information table 113.

The control status determining part 1401 in the management server 101 determines a control rule to be applied to each mobile terminal 131 based on the terminal positional information 113A and the allocated policy 113B of each mobile terminal 131, and stores the control rule as a control status 113C. The control information transmitting part 1402 transmits the determined control rule to each mobile terminal 131 via the communication network 121 and the mobile terminal management server 1403.

Because the applied policy determining process that is performed by the control status determining part 1401 is the same as the one performed by the control status determining part 143 according to the first embodiment illustrated in FIG. 9, the detailed description is omitted. It should be noted however that according to the second embodiment, the control status determining part 1401 refers to the policy table 112 and the terminal information table 113 as needed instead of the allocated policy information 148. Step 901 includes a procedure of receiving terminal information from each mobile terminal 131 via the mobile terminal management server 1403 by the terminal information receiving part 109. Step 913 includes a procedure of transmitting a control rule defined by the determined applied policy to each mobile terminal 131 via the mobile terminal management server 1403. Each mobile terminal 131 controls the functions of the information input parts such as the audio input part 135 and the image information input part 137 based on the transmitted control rule.

FIG. 14C is a block diagram illustrating the configuration of the mobile terminal management server 1403 according to the second embodiment of this invention.

The mobile terminal management server 1403 includes a CPU 1411, a network I/F 1412, a memory 1413, and a storage area 1414 which are connected to one another.

The CPU 1411 is a processor that performs various processes in accordance with a program stored in the memory 1413. A program for the mobile terminal management server that is run by the CPU 1411 is stored in the memory 1413. A control information receiving part 1415, a control information transmitting part 1416, a terminal information transmitting part 1417, and a terminal information receiving part 1418 illustrated in FIG. 14C are program modules that constitute the mobile terminal management server program or a part thereof. The processes that are performed by those parts are described later.

A terminal information table 1419 is stored in the storage area 1414. The terminal information table 1419 includes information on each mobile terminal 131. In the example of FIG. 14C, the terminal information table 1419 includes terminal positional information 1419A and a control status 1419B in addition to the identification information (not shown) of each mobile terminal 131. Those pieces of information are respectively similar to the terminal positional information 113A and the control status 113C held in the management server 101.

When receiving terminal information including the terminal positional information 147 from each mobile terminal 131, the terminal information receiving part 1418 stores the terminal positional information 147 as terminal positional information 1419A in the storage area 1414. The terminal information transmitting part 1417 transmits the terminal information received by the terminal information receiving part 1418 to the management server 101. The terminal information receiving part 109 of the management server 101 stores the terminal positional information 147 included in the received terminal information as terminal positional information 113A in the storage area 111.

When receiving control information including the control status 113C of each mobile terminal 131 from the management server 101, the control information receiving part 1415 stores the control status 113C as control status 1419B in the storage area 1414. The control information transmitting part 1416 transmits the control information received by the control information receiving part 1415 to each mobile terminal 131.

The memory 1413 and the storage area 1414, similarly to the memory 106 and the storage area 111 of the management server 101, may be achieved by any kind of storage device.

The network I/F 1412 is the interface that couples the mobile terminal management server 1403 to the communication network 121, and is used for communication between the mobile terminal management server 1403 and the management server 101 and communication between the mobile terminal management server 1403 and the mobile terminal 131.

FIG. 14D is a block diagram illustrating the configuration of the mobile terminal 131 according to the second embodiment of this invention.

The policy receiving part 141 and the control status determining part 143 are not held in the memory 140 of the mobile terminal 131 according to the second embodiment, but a control information receiving part 1404 which is a program module that constitutes the mobile terminal program or part thereof is held in the memory 140 instead. In addition, transmission and reception of information that are performed by the terminal information transmitting part 142 and the control information receiving part 1404 with respect to the management server 101 are carried out via the mobile terminal management server 1403. The mobile terminal 131 controls the functions of the information input part or the like of the mobile terminal 131 based on the control status 113C included in the control information received by the control information receiving part 1404.

The mobile terminal 131 according to the second embodiment is the same as the mobile terminal 131 according to the first embodiment in the above-mentioned point. Because the configurations other than that of the mobile terminal 131 according to the second embodiment have the same functions as those of the above-mentioned configurations illustrated in FIG. 1C and given the same reference numerals, their descriptions are omitted.

According to the above-mentioned embodiments of this invention, the management server 101 holds and distributes policies for controlling the functions of the plurality of mobile terminals 131 to enable centralized management of the functions of the plurality of mobile terminals 131, thereby preventing an unauthorized operation of the mobile terminal 131 and information leakage or the like via the mobile terminal 131. Each policy is associated with a geographical area, and each mobile terminal 131 applies a control rule for the functions based on its own positional information and the geographical area of the policy. At this time, an error in positional information is considered, and hence when a plurality of policies can be applied, it is determined which control rule should be applied based on the priority or the like. Accordingly, even when positional information contains an error, it is possible to prevent an unauthorized operation of the mobile terminal 131 and information leakage or the like via the mobile terminal 131.

Information on programs, tables, files, and the like that achieve the individual functions of the above-mentioned embodiments may be stored in a storage device, such as a nonvolatile semiconductor memory, a hard disk drive, and a solid state drive (SSD), or a non-transitory computer readable data storage medium, such as an IC card, an SD card, and a DVD.

This invention is not limited to the above-mentioned embodiments, and includes various modifications. For example, the above-mentioned embodiments have been described in detail for ease of understanding of this invention, and should not be limited to a mode having all the configurations described herein. Further, part of the configuration of one embodiment may be replaced with the configuration of another embodiment, or the configuration of one embodiment may be added with the configuration of another embodiment. Further, part of the configuration of each embodiment may be added with another configuration, deleted, or substituted with another configuration.

What is claimed is:

1. An information system, comprising:
a plurality of mobile devices; and
a management server that communicates with the plurality of mobile devices over a network,
the management server comprising a first interface for communicating with the plurality of mobile devices over the network, a first processor coupled to the first interface, and a first storage device coupled to the first processor,
each of the plurality of mobile devices comprising a second interface for communicating with the management server over the network, a second processor coupled to the second interface, a second storage device coupled to the second processor, an information input part coupled to the second processor, for acquiring a predetermined type of information from outside the each of the plurality of mobile devices, and a positional information acquiring part for acquiring positional information of the each of the plurality of mobile devices,
the management server being configured to hold, in the first storage device, a plurality of policies each including a control rule for the information input part and information specifying a geographical area to which the control rule is applied,
one of the management server and the each of the plurality of mobile devices being configured to determine whether a location of the each of the plurality of mobile devices acquired by the positional information acquiring part is included in at least one geographical area specified by at least one policy in the plurality of policies, and specify the control rule to be applied to the each of the plurality of mobile devices based on the at least one policy when the location of the each of the plurality of mobile devices acquired by the positional information acquiring part is included in the at least one geographical area specified by the at least one policy,
the each of the plurality of mobile devices being configured to control the information input part based on the control rule to be applied to the each of the plurality of mobile devices.

2. The information system according to claim 1, wherein:
the information input part has a function of acquiring at least one of image information or audio information; and
a control rule specified by each of the plurality of policies represents one of permission, inhibition, and restriction of the acquisition of the at least one of the image information or the audio information by the information input part.

3. The information system according to claim 2, wherein:
the each of the plurality of policies further includes information representing priority of the each of the plurality of policies; and
when the location of the each of the plurality of mobile devices acquired by the positional information acquiring part is included in at least two geographical areas specified by at least two policies in the plurality of policies, one of the management server and the each of the plurality of mobile devices specifies the control rule specified by a policy which has a highest priority among the at least two policies as the control rule to be applied to the each of the plurality of mobile devices.

4. The information system according to claim 3, wherein:
the first storage device further holds information representing a rule for selecting a policy; and
when the information representing the rule for selecting a policy represents merging of a plurality of policies, and the location of the each of the plurality of mobile devices acquired by the positional information acquiring part is included in the at least two geographical areas specified by the at least two policies, one of the management server and the each of the plurality of mobile devices specifies a control rule generated by merging at least two control rules specified by the at least two policies as the control rule to be applied to the each of the plurality of mobile devices.

5. The information system according to claim 4, wherein, when a positional range of the each of the plurality of mobile devices specified by an error in the location of the each of the plurality of mobile devices acquired by the positional information acquiring part at least partly overlaps at least two geographical areas specified by at least two policies in the plurality of policies, one of the management server and the each of the plurality of mobile devices specifies the control rule specified by a policy which has a highest priority among the at least two policies as the control rule to be applied to the each of the plurality of mobile devices.

6. The information system according to claim 5, wherein:
the each of the plurality of mobile devices further comprises an image display part coupled to the second processor, and is further configured to:
hold map information; and
hold at least one policy including a control rule to be applied to the each of the plurality of mobile devices; and
the image display part is configured to:
display a map based on the map information; and
display, on the map, at least one geographical area specified by the at least one policy, and at least one of identification information of the at least one policy or at least one control rule specified by the at least one policy.

7. The information system according to claim 6, wherein:
the management server further comprises an input apparatus coupled to the first processor, for receiving an input of information from a user;
when the plurality of policies are input to the input apparatus, the management server holds the input plurality of policies in the first storage device, and transmits the plurality of policies to the each of the plurality of mobile devices; and
the each of the plurality of mobile devices determines, based on the transmitted plurality of policies, whether the location of the each of the plurality of mobile devices acquired by the positional information acquiring part is included in at least one geographical area specified by at least one policy in the plurality of policies, and specifies a control rule to be applied to the each of the plurality of mobile devices based on the at least one policy when the location of the each of the plurality of mobile devices acquired by the positional information acquiring part is included in the at least one geographical area specified by the at least one policy.

8. A control program for a management server that communicates with a plurality of mobile devices over a network,
the management server comprising a first interface for communicating with the plurality of mobile devices over the network, a first processor coupled to the first interface, and a first storage device coupled to the first processor,
each of the plurality of mobile devices comprising a second interface for communicating with the management server over the network, a second processor coupled to the second interface, a second storage device coupled to the second processor, an information input part coupled to the second processor, for acquiring a predetermined type of information from outside the each of the plurality of mobile devices, and a positional information acquiring part for acquiring positional information of the each of the plurality of mobile devices,
the control program controlling the first processor to perform:
a first step of holding, in the first storage device, a plurality of policies each including a control rule for the information input part and information specifying a geographical area to which the control rule is applied; and
one of a second step of transmitting the plurality of policies to the each of the plurality of mobile devices, and a third step of transmitting a control rule specified based on at least one policy in the plurality of policies to the each of the plurality of mobile devices.

9. The control program for a management server according to claim 8, wherein:
the information input part has a function of acquiring at least one of image information or audio information; and
a control rule specified by each of the plurality of policies represents one of permission, inhibition, and restriction of the acquisition of the at least one of the image information or the audio information by the information input part.

10. The control program for a management server according to claim 8, wherein:
the each of the plurality of policies further includes information representing priority of the each of the plurality of policies; and
the third step comprises determining whether a location of the each of the plurality of mobile devices acquired by the positional information acquiring part is included in at least two geographical areas specified by at least two policies in the plurality of policies, and transmitting a control rule specified by a policy which has a highest priority among the at least two policies to the each of the plurality of mobile devices when the location of the each of the plurality of mobile devices acquired by the positional information acquiring part is included in the at least two geographical areas specified by the at least two policies.

11. The control program for a management server according to claim 8, wherein the third step comprises transmitting, when a location of the each of the plurality of mobile devices acquired by the positional information acquiring part is included in at least two geographical areas specified by at least two policies in the plurality of policies, a control rule generated by merging at least two control rules specified by the at least two policies to the each of the plurality of mobile devices.

12. The control program for a management server according to claim 8, wherein:
the each of the plurality of policies further includes information representing priority of the each of the plurality of policies; and
the third step comprises determining whether a positional range of the each of the plurality of mobile devices specified by an error in a location of the each of the plurality of mobile devices acquired by the positional information acquiring part at least partly overlaps at least two geographical areas specified by at least two policies in the plurality of policies, and transmitting a control rule specified by a policy which has a highest priority among the at least two policies to the each of the plurality of mobile devices when the positional range of the each of the plurality of mobile devices at least partly overlaps the at least two geographical areas specified by the at least two policies.

13. The control program for a management server according to claim 8, wherein:
the control program controls the first processor to perform the second step;
the each of the plurality of mobile devices further comprises an image display part coupled to the second processor, and is configured to:
hold map information; and
hold at least one policy including a control rule to be applied to the each of the plurality of mobile devices; and
the image display part is configured to:
display a map based on the map information; and
display, on the map, at least one geographical area specified by the at least one policy, and at least one of identification information of the at least one policy or at least one control rule specified by the at least one policy.

14. The control program for a management server according to claim 8, wherein:
the management server further comprises an input apparatus coupled to the first processor, for receiving an input of information from a user;
the first step comprises holding, when the plurality of policies are input to the input apparatus, the input plurality of policies in the first storage device; and
the control program controls the first processor to perform the second step.

15. A control program for a mobile device that communicates with a management server over a network,
the management server comprising a first interface for communicating with a plurality of the mobile devices over the network, a first processor coupled to the first interface, and a first storage device coupled to the first processor,
the mobile device comprising a second interface for communicating with the management server over the network, a second processor coupled to the second interface, a second storage device coupled to the second processor, an information input part coupled to the second processor, for acquiring a predetermined type of information from outside the mobile device, and a positional information acquiring part for acquiring positional information of the mobile device,
the management server being configured to hold, in the first storage device, a plurality of policies each including a control rule for the information input part and information specifying a geographical area to which the control rule is applied,
the control program controlling the second processor to perform a first step of controlling the information input part based on the plurality of policies, a plurality of geographical areas specified by the plurality of policies, and a control rule specified based on a location of the mobile device acquired by the positional information acquiring part.
